(19) United States
(12) Patent Application Publication
(10) Pub. No.: US 2011/0004902 A1
(43) Pub. Date: Jan. 6, 2011

(54) SYSTEM AND METHOD FOR PROVIDING CONTENT STREAM FILTERING IN A MULTI-CHANNEL BROADCAST MULTIMEDIA SYSTEM

(76) Inventors: Mark Alan Schultz, Carmel, IN (US); Ronald Douglas Johnson, Westfield, IN (US); Matthew Robert Lamb, Westfield, IN (US)

Correspondence Address: Robert D. Shedd, Patent Operations;THOMSON Licensing LLC, P.O. Box 5312, Princeton, NJ, 08543-5312, US

(21) Appl. No.: 12/736,033

(22) PCT Filed: Nov. 7, 2008
(86) PCT No.: PCT/US2008/012601

§ 371 Date: Sep. 1, 2010

(51) Int. Cl. H04N 5/445

(52) U.S. Cl. 725/39

(57) ABSTRACT

A system for providing content stream filtering in a broadcast multimedia system having a global pause function includes a pre-pause controller configured for processing audio and video data content prior to the global pause function, the data content being received from a packet processor. The pre-pause controller includes an analyzer module for acquiring and analyzing program guide data to apply selection criteria to determine desired content to be stored in a pause function memory device, a filtration module for filtering out undesired content and enabling desired data content comprising primary filtered content to be saved in at least one pause function memory device, and a guide module for creating a program guide comprising only primary filtered content to be offered to viewers. A post-pause controller is provided for processing content subsequent to the global pause function, the post-pause controller including a user-customized filtration module for filtering the primary filtered content in accordance with viewer requests.

### BACKGROUND

Individual pause systems are used all over the world to adjust time to accommodate the viewer. Pause functions are well known in devices such as VCRs. For example, if the audio/video source is a VCR tape or tapes, a pause can be implemented by simply pressing the pause button on the VCR and then pressing ‘play’ when an interruption period is ended to resume playback of the program(s). This form of pause typically does not require any special design techniques. Indeed, a simple pause function for a single program is found today in many homes on a Personal Video Recorder (PVR) or Digital Video Recorder (DVR) unit. The PVR can have a specific design to record and playback programs as specified by its user. In almost all cases, only single programs are adjusted in time and not an entire system. One complication with individual storage systems is that if the viewer changes stations during the program, unless the other program has an equal pause, he will not be able to go back to his original station without losing portions of the original program.

However, providing a pause function in a real time digital streaming environment with hundreds of channels available, such as in an airplane satellite system, presents a challenging problem. Pausing the entire incoming satellite program content at, e.g., 3 Gbits/second on, e.g., an airplane is a massive undertaking insofar as memory requirements. However, many programs are either not suitable for viewing on, e.g., a plane (e.g., due to their ratings such as Rated R) or are otherwise unlikely to be used or viewed by a particular viewing audience. Accordingly, a system and method for streamlining pause functionality and capability in systems without comprising services provided, is highly desirable.

### SUMMARY

In one embodiment according to the present principles, a system and method is provided for reducing the amount of data stored in a pause database in a broadcast television system while still ensuring provision of all desired services to the viewers watching live broadcast television programming, e.g., live satellite program content on, e.g., an aircraft, bus, train, theater, etc. Advantageously, all but the eligible system programs are filtered out to reduce the data required to be stored in a paused database while still providing every desired service on, e.g., the plane. While the present principles are described with respect to implementation for aircraft-specific systems, they are not intended to be limited as such and can be implemented in any system in which a reduction of stored data in a system capable of, e.g., a global pause, is desired.

A system and method according to the present principles provides a system that significantly reduces the memory required for providing a global pause function by filtering out inappropriate, undesired or otherwise ineligible programs for the passengers to watch. The present system shows how to reduce the memory size without reducing the features available to the passengers. This advantageously reduces the memory cost and enables the addition of features that might not be possible without the data reduction. Indeed, in many cases, the features which can be offered to passengers are actually increased since additional bandwidth is now available to allow, e.g., video on demand services or at least multiple start times for the same content.

The present system is particularly applicable to systems where a global schedule pause feature is provided configured to store all of the delivered streams in a buffer, and to enable the delivery of the streamed content to the viewer at time-delayed start times. In such a system, the viewers would therefore not miss any of the program content for any of the channels.

In the present system, when a live satellite service on, e.g., an airplane is starting up, the guide information is acquired, the available programs for the passengers assembled, and then a user interface guide is built that only shows the selectable programs on that particular flight. The system uses the selected program information to filter out all of the undesired programs as they arrive from the transponders in real time. Accordingly, the database is reduced from all ineligible programs, rather than keeping only selected programs by the passengers. A second gateway after the pause function will then further reduce the programs to those only selected by the passengers.

Any criteria can be used to determine which data streams should be filtered. For example, the types of programs that would typically be filtered on a flight would be pay-per-view streams, long movies that occur on a short flights, programs that are already, e.g., half over, the programs that have ratings that are more restrictive than the plane's requirements (such as ‘R’ rated content may not be allowed on the plane), certain advertising channels, gaming programs, and some satellite system support packets, etc. Programs that might be kept are G or PG rated programs that fit within the flight time, news programs, nature programs, and free live sports events.

Since the database is cut to a fraction of the original amount, less memory is required for the pause function. Less memory can also translate into more features since it also reduces the memory bandwidth requirements. If bandwidth is available, the most popular programs can be offered to start at multiple, repeated intervals, such as every 5 minutes, without having a big impact on the amount of storage or seriously loading down the system.

In one aspect of the present principles, a system for providing database filtering in a broadcast multimedia system having a global pause function is provided comprising a pre-pause controller configured for processing audio and video data content received from a packet processor, the pre-pause controller comprising an analyzer module for acquiring and analyzing program guide data to apply selection criteria to determine desired content to be stored in a pause function memory device, a filtration module for filtering out undesired content and enabling desired data content comprising primary filtered content to be saved in at least one pause function memory device, and a guide module for creating a program guide comprising only primary filtered content to be offered to viewers.

According to another aspect, a system for providing database filtering in a broadcast multimedia system having a global pause function is provided comprising a pre-pause controller configured for processing audio and video data content prior to the global pause function, said data content being received from a packet processor, the pre-pause controller comprising an analyzer module for acquiring and analyzing program guide data to apply selection criteria to determine desired content to be stored in a pause function memory device, a filtration module for filtering out undesired content and enabling desired data content comprising primary filtered content to be saved in at least one pause function memory device, and a guide module for creating a program guide comprising only primary filtered content to be offered to viewers. A post-pause controller is provided for processing content subsequent to the global pause function, the post-pause controller including a user-customized filtration module for filtering the primary filtered content in accordance with viewer requests.

According to yet another aspect, a method for providing database filtering in a broadcast multimedia system having a global pause function is provided, the method comprising receiving data content from at least one tuner, acquiring and analyzing program guide data to apply selection criteria to the data content to determine desired data content to be stored in a pause function memory device, and filtering out undesired data content and providing the desired data content comprising primary filtered content to be saved in at least one pause function memory device.

These and other aspects, features and advantages of the present principles will be described or become apparent from the following detailed description of the preferred embodiments, which is to be read in connection with the accompanying drawings.

### BRIEF DESCRIPTION OF THE DRAWINGS

In the drawings, wherein like reference numerals denote similar elements throughout the views:

FIG. 1 is an exemplary illustration of a packet processor in a satellite broadcast system;

FIG. 2 is an exemplary illustration of a pause packet processor configured for providing a global pause function;

FIG. 3 is an exemplary schematic diagram of a system setup for providing database filtering in a broadcast multimedia system having a global pause function according to an aspect of the present principles;

FIG. 4 is an exemplary schematic diagram of a system setup for providing database filtering in a broadcast multimedia system having a global pause function according to another embodiment;

FIG. 5 is an exemplary method flow for providing database filtering in a broadcast multimedia system having a global pause function according to an aspect of the present principles; and

FIG. 6 is an exemplary schematic illustration of a pre-pause controller and a post-pause controller according to an aspect of the present principles.

It should be understood that the drawings are for purposes of illustrating the concepts of the present principles and are not necessarily the only possible configurations for illustrating the present principles.

### DETAILED DESCRIPTION

A method, apparatus and system for providing content stream filtering in a universal or global pause system for broadcast programming is advantageously provided according to various aspects of the present principles. Although the present principles will be described primarily within the context of an aircraft (in-flight) programming and pause system and method, the specific embodiments of the present principles should not be treated as limiting the scope of the invention. It is appreciated by those skilled in the art and informed by the teachings of the present principles that the concepts of the present principles can be advantageously applied in other environments in which database filtering in a global program pause function is desired, e.g., broadcast television/radio, satellite radio, cable, etc., in environments having contained, limited audiences such as theaters, and in transportation means such as buses, trains, etc.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it is appreciated by those skilled in the art that the block diagrams presented herein represent conceptual views of illustrative system components and/or circuitry embodying the principles of the invention. Similarly, it is appreciated that any flow charts, flow diagrams, state transition diagrams, pseudocode, and the like represent various processes which can be substantially represented in computer readable media and so executed by a computer or processor, whether or not such computer or processor is explicitly shown.

In accordance with various embodiments of the present principles, a method, apparatus and system is described for providing database filtering in a system providing a system-wide or ‘global’ pause function, namely, for reducing overall content to be stored and processed during a simultaneous pause of multi-channel broadcast multimedia/television content broadcast to a plurality of viewers in real time. While the present principles can be applicable to any broadcast television system, the examples herein are described in relation to, e.g., aircraft satellite television environments in which television content is displayed to passengers either individually, e.g., in seat-back displays, or in groups, e.g., via a plurality of displays distributed throughout the passenger cabin. Generally, most system providers provide systems with individual controls since people generally desire independence in controlling programming content. However, passengers on trains, buses, theaters, and especially airplanes, tend to be captive audiences. In addition, transportation vehicles typically have varying departure times and schedules, which do not necessarily match broadcast program schedules.

Thus, a system and method for improved implementation of and expanded services in a global pause system is especially desirable and useful.

According to one aspect of a global pause system, a pause function can be implemented on, e.g., an airplane which has the capability of allowing most of the viewed content to be snapped to, e.g., a 30 minute interval so passengers can view entire programs rather than portions of programs, and so none of the desired program content is missed. This is advantageous if the plane leaves at 9:40 and a passenger wants to watch a show that started at 9:30. The passenger would miss 10 minutes without pause, or see the entire show with a 10 minute pause. Since the data is stored once, the capability of reading the data multiple times with, e.g., 5 minute start delays is also a possibility.

A global pause system enables channel surfing for the first few minutes across all of the potential programs within the same timeframe. Since all programs are recorded, switching between stations is not a problem since every channel has been recorded at the same time, rather than just the one channel the passenger is watching at any given time.

Given enough bandwidth in the memory, the system could store the data once but read it back at certain time intervals (e.g., 5-10 minute intervals) to accommodate multiple viewers requesting shows at multiple times. The system can implement a pause function to store the data and control the playback of the data.

It is to be noted that each receiver (set top box) can be configured for local storage and allow individual user-enabled ‘local’ pause functions (e.g., to allow each user to activate a pause mode to pause content at a user-desired time). However, according to one aspect of the present principles, content stream filtering in a system having a ‘global’ or universal pause feature is further provided which does not require user activation and minimizes storage requirements. For example, storage requirements can be drastically reduced since programs can be stored once in a single controller, rather than storing the same content in each of the passenger seats if a local pause function was used. Note also that a global pause function (e.g., a pause function next to the tuners) advantageously allows users/viewers to change content or channels or customize viewing schedules during, e.g., a flight without encountering problems such as loss of data created with previous pauses. For example, a local pause function at each viewer's set top box would typically cause the loss of data whenever a channel change occurs after a pause has been implemented. The loss of data would be the time equal to the sum all of the pauses up to the point of channel change.

Advantageously, a system and method according to the present principles provides a streamlined and efficient manner in which to provide global pause functionality with enhanced services. The present system and method avoids complexity and minimizes the amount of memory needed, thus reducing costs. In one aspect, a pre-pause controller is provided having a system filtration module for automatically filtering content prior to being stored for a pause function. In another aspect, a post-pause controller is provided having a user-customized filtration module for enabling viewers to filter the pre-filtered content to deliver requested programs.

Due to the filtering processes according to the present principles, additional services such as video-on-demand or offering programs to the viewers at multiple start times, can be provided and maximized. For example, each viewer can enjoy viewing of any video/audio programming content at a desired start time selected from multiple start times, and will not miss any of the content, regardless of what channel each individual viewer was watching and without having to manually activate any controls.

Further, the viewer can be given a choice between viewing a program in real time or at a delayed time. This would be advantageous since some programs such as the news or sports might be desirable to be viewed in real time. If a passenger requests to start a program 20 minutes into the flight but everyone else started 10 minutes into the flight, it is still possible to accommodate his request since the data exists in memory and multiple start times can be provided.

A system and method according to the present principles screens incoming packets to preselect the programs to be saved in memory. Customized criteria for can be taken into consideration for determining which programs are to be saved. Preferably, only program content which is popular and/or appropriate or likely to be viewed is stored. Advantageously, this reduction in data allows new services such as providing multiple delayed starts of the same program or offering, e.g., a 30 minute program every 30 minutes which was only available every 6 hours via satellite.

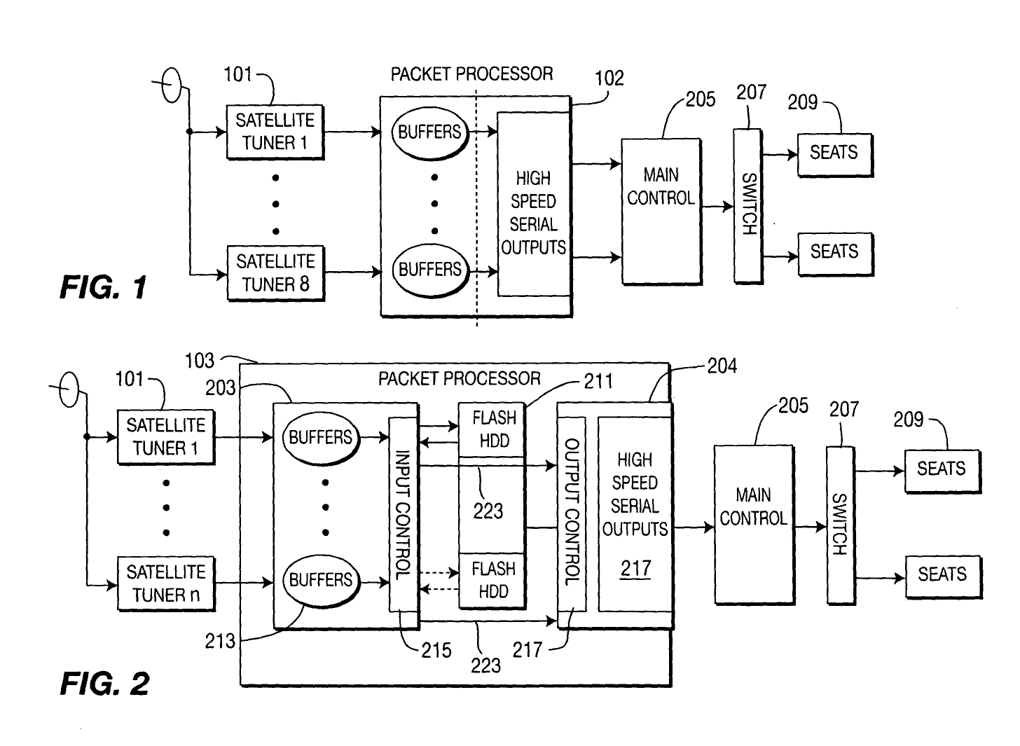

Referring now to the Figures, FIG. 1 is an exemplary illustration of a packet processor 102 in an aircraft satellite broadcast system. A plurality of tuners 101 (e.g., tuners (1 through n)) can be provided, each tuner being configured to receive and process audio/video signals via, e.g., satellite. Each tuner 101 or a group of tuners (1 through n) is connected to a network or packet processor 102 configured to process packet data transferred from each tuner 101. Multiple packet processors 102 can be provided. Packet processors 102 can include certain features or architectures to enhance and optimize packet processing, such as pattern matching (the ability to find specific patterns of bits or bytes within packets in a packet stream), data bit field manipulation (the ability to change certain data fields contained in the packet as it is being processed), and queue management (as packets are received, processed and scheduled to be send onwards, they are stored in queues).

Each packet processor 102 is connected to a main controller 205, which itself is connected to and controlled by a switch 207. The switch 207 can comprise, e.g., an 8 port 1000base T switch and can be configured for controlling signal output to any number or grouping of seats 209 (e.g., a plurality of seating ‘zones’). For example, switch 107 can be configured for distributing signals to a plurality of zones, each zone including a set top box (STB) receiver which can be functionally connected to a plurality of seat monitors. Any number of seats per STB receiver can be contemplated. For example, each STB can be connected to each other via a ‘daisy chain’ wiring scheme (electrical bus) configuration.

FIG. 2 is an exemplary illustration of a pause packet processor 103 configured for providing a global pause function e.g., in an aircraft satellite television system. The processor 103 can include a capture/input module 203, a memory 211 and an output module 204 each in functional communication with one another. The capture module 203 and output module 204 can include a plurality of buffers 213 (not shown in module 204), which can preferably comprise, e.g., first-in-first-out (FIFO) buffers configured to process data such that the first data to be added to the queue is the first data to be removed, and processing proceeds sequentially in the same order. It is noted that the buffers 213 can also be included in the output control 217 of module 204.

The memory 211 can comprise any memory device, such as a hard disk drive (HDD), and/or preferably a non-volatile, solid-state memory device such as flash memory, which can be a more durable, efficient and suitable storage media, especially in high-altitude environments where air pressure might fluctuate, such as in airplane cabins. Since the majority of interruption periods, e.g., during a flight, can comprise announcements lasting only a minute or two, a minimum amount of memory is needed to cover a minimal system. Preferably, the memory 211 has storage capacity of, e.g., at least about 45 Mb/s for each transponder (an exemplary system setup can comprise, e.g., 32 tuners tracking 32 transponders).

Incoming data transport streams are input from tuners 201 to the buffers 213 for processing by the input module 203. The input module 203 can include an input controller 215, which itself can comprise at least a system control, an incoming timestamp counter, and an outgoing timestamp counter (not shown). The incoming timestamp counter adds marker values/timestamps to incoming packets to register and acknowledge when packets are received and to improve data flow. For example, the incoming timestamp counter is configured for marking when each incoming packet arrives from the tuner (e.g., by applying a time-based marker value to each incoming packet) and the outgoing timestamp counter provides time-based marker values for each outgoing packet.

For example, as incoming serial packets are received they are byte aligned and if it is determined that there is a new packet start, a timestamp is added, preferably to the packet header. In addition, the packet can be flagged with an extra ‘start bit’ to show when a packet begins. An exemplary timestamp can comprise, e.g., a 16 bit counter with a known clock reference that can be reset, programmed, or pre-loaded by the system controller. For example, a time reference about equal to ½ of the minimum single packet delivery time (˜16 to 18 μs) can be used as the time stamp clock reference.

For example: Consider a 27 MHz clock reference that takes 1/27,000,000=37 ns per bit. Packets of 130 bytes*8 bits/byte=1040 bits. 37 ns*1040=38.5 μs per packet.

It is desirable to mark packets at least within one packet time so let's pick ½ of a packet time which is ˜19 us so the frequency would be 1/19 us=˜53 KHz. As an estimate, we use 2̂10=1024 bits and took half of this as 512 which is 2̂9. Therefore:

Clock reference/(bits/packet)/2=27 MHz/130*8/2=27 MHz/520=˜52 KHz

Note that the addition of timestamps can result in the addition of extra data to each packet. For example, whenever a start bit is found, two bytes of timestamp data can be added to the packet header. The time-stamped packets are then sent to the buffer 213 and on to the memory 211 for storage. As an example, an unstamped packet can comprise 130 bytes versus a time-stamped packet at 132 bytes.

Preferably, the software (e.g., processor 103) can build and store a navigation table/register using set intervals of time to contemporaneously record the IN_timestamp and the memory address in memory 211 where this data starts. This register can be used to keep track of where data is found in memory 211 with respect to its timestamp. Advantageously, this would enable very quick access to the desired data once a known delay or pause period is defined.

The outgoing timestamp counter provides the output timestamps. Note that the OUT_timestamp counter can be analogous in configuration and operation to the IN_timestamp counter. The outgoing timestamp counter can use the same type of counter and same clock reference as the input timestamp counter but the specific outgoing timestamp value will typically be equal or less than the incoming timestamp counter. This is because the outgoing counter provides the timestamp for the memory access that represents the time that the viewer is watching. When a global pause occurs (pause mode/period begins), the outgoing counter is stopped until the pause period is ended. This pause in the counting means the outgoing count/marker value normally is lower than the incoming count value. The outgoing counter reference with a lower value than the input counter reference indicates that the value is further back in time, which tracks the location of the start of the pause feature in the time domain.

The outgoing counter is preferably configured to be able to be reset, programmed, and/or pre-loaded by the system controller. Both counters are cleared at the start of the video service and begin counting, e.g., by setting both count enables high. The IN_timestamp counter is constantly counting/marking incoming packets independent of any pause mode (i.e., regardless of whether the system is in a pause mode or non-pause mode) since it provides the timestamp/marker value for incoming data. The OUT_timestamp counter also counts and follows the IN_timestamp counter, but stops incrementing/counting whenever a global pause mode is enabled.

For example, in the timeline shown below (Example 1) depicting an exemplary period of 20 minutes of streaming data content, a 5 minute pause period occurs starting from minute 10 to minute 15. While the data input continues to be written throughout the entire 20 minutes, at 10 minutes, the data output (reading) is stopped and the outgoing timestamp counter/marker value is noted. When the pause period is over at minute 15, the output counter searches for the output timestamp counter value (minute 10) in the input time-stamped data to resume playback starting from minute 10. Note that after the pause, the next packet of data output would be the one following the last packet sent before the pause. The primary purpose of the timestamp counters is to ensure that the original transmission bitrate is maintained to avoid MPEG buffer overflows or underflows.

### Example 1

| | | 10 min | 15 min | |
|---|---|---|---|---|
| | 0 min . . . | (pause start) | (pause end) | . . . 20 min. |
| In count: | 0 . . . | 10 . . . | 15 . . . | 20 . . . |
| Out count: | 0 . . . | 10 . . . | 11 12 13 . . . | 15 . . . 20 |

The input controller 215 is configured for both writing and reading the streaming data to or from memory 211. Details of the read and write operations and signals of the memory controller and interfaces are well known in the art and are not shown. Note that in all cases, the controller 215 is configured to continuously write incoming streams to the memory 211. Even during a pause period, although the system would not be reading (outputting) the data from the memory 211, incoming data would still need to be written. When the pause period is over and playback is resumed, both reading of the playback data and writing of the incoming data are simultaneously performed.

In one embodiment, a multiplexer can be added (e.g., see 223 in FIG. 2) to this system, to enable switching between either real-time or stored (paused) content from the memory 211. For instance, guide packets could be passed in real time to the receivers to maintain appropriate real time clock references versus the paused clock references. This multiplexer could also be used for live video and audio feeds from the cockpit during the pause modes to allow the data flow.

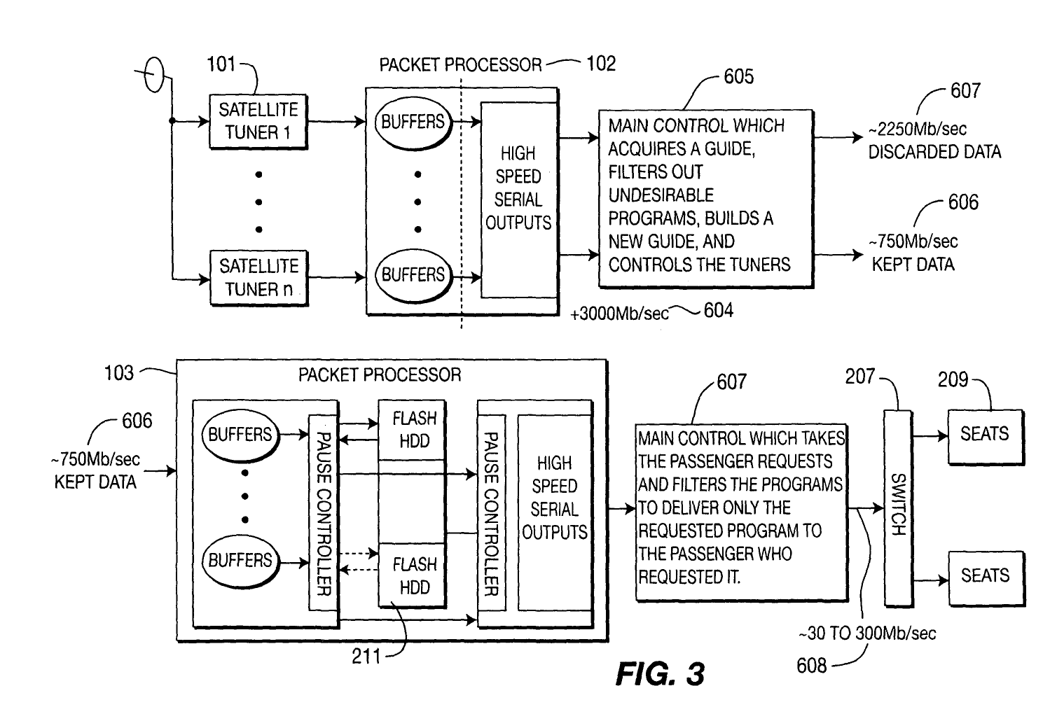

FIG. 3 is an exemplary schematic diagram of a system setup for providing database filtering in a broadcast multimedia system having a global pause function according to an aspect of the present principles. The system includes a pre-pause controller 605 which operates as an additional gateway or filter to allow data filtering both before and after a pause function provided by the packet processor 103. A post-pause controller 607 can be provided to assess viewer requests and filter the resultant programs to deliver the requested content. Advantageously, the pause packet processor 103 has a much reduced amount of data which it needs to process and store, which allows a wider range of services, such as providing multiple delayed start times of the same program, offering a 30 minute program every 30 minutes (as opposed to only every 6 hours via live satellite), etc.

In FIG. 3, the pre-pause control 605 can connected to a packet processor 102, which receives data streams from tuners 101. The pre-pause control 605 is configured for receiving all the programs from packet processor 102 and filtering the programs to provide a reduced amount of programs (primary filtered programs 606), as desired by the service provider (e.g., satellite video service).

In this example, the data reduction is shown in bits/second, as opposed to percentages. For example, incoming data 604 to the pre-pause controller 605 at 3000 Mb/sec can be filtered to discard around 2250 Mb/sec of data, and the 750 Mb/sec of kept data is sent to pause packet processor 103 for storage in memory.

A post-pause controller 607 is provided functionally connected to the pause processor 103 for performing a second filtering process, e.g., for assessing viewer program requests and further filtering the primary filtered programs 606 to eliminate programs that the passengers/viewers do not wish to view. This results in ‘secondary filtered content’ comprising user-specified data content being sent to viewers. Thus, an even further reduction in the overall amount of data to be output to the viewers is provided. In accordance with the example shown in FIG. 3, in delivering user-requested programs, the post-pause controller 607 can send secondary filtered content 608 (here comprising approximately 30 to 300 Mb/sec) to the viewers 209. The numerical values shown are for illustrative purposes only, and not by way of limitation.

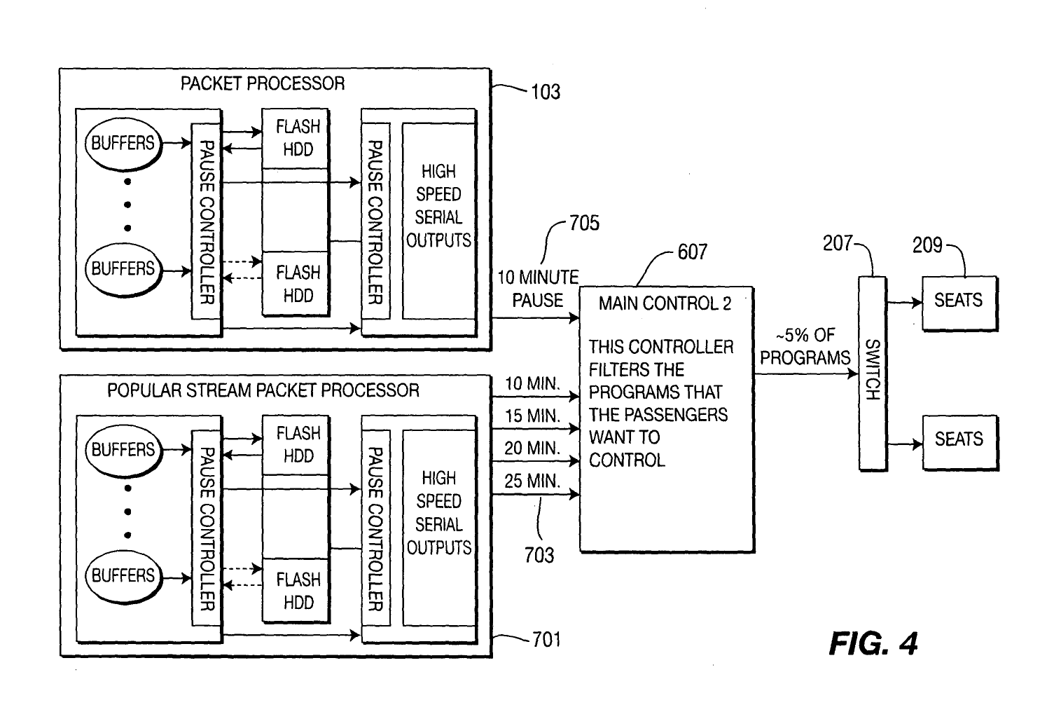

FIG. 4 is an exemplary schematic diagram of a system setup for providing database filtering in a broadcast multimedia system having a global pause function according to another embodiment. In this embodiment, a separate “popular stream” packet processor 701 can be provided in addition to the pause packet processor 103. The popular stream processor 701 is configured to store programs which are desired by or otherwise deemed most suitable for or likely to be watched by viewers. The packet processor 103 stores the remaining streams in a normal manner.

The stored programs of processor 103 can be paused for a certain time interval, which can be dependent on the limits of the system memory and bandwidth, for example, as shown here a 10 minute delay can be provided for all its stored programs. Since the popular stream processor 701 typically processes a much reduced amount of data streams, multiple delayed starts 703 can be provided in which a single ‘popular’ program can be viewed at multiple start times, e.g., with a 10 minute delay, a 15 minute delay, a 20 minute delay, etc. The amount of time delay (pause buffer) which can be provided for each program depends on the total amount of memory available.

In addition, the popular stream processor 701 can be configured to offer a program at more frequent viewing times. For example, where a 30 minute program was offered only every 6 hours on live satellite television, the system and method according to the present principles can offer it at more frequent intervals, such as every 30 minutes.

The post-pause controller 607 is provided functionally connected to both the pause processor 103 and popular stream packet processor 701 for performing a second filtering process, e.g., for assessing viewer program requests and further filtering the programs sent from processors 103, 701 to only select programs that the passengers/viewers wish to view.

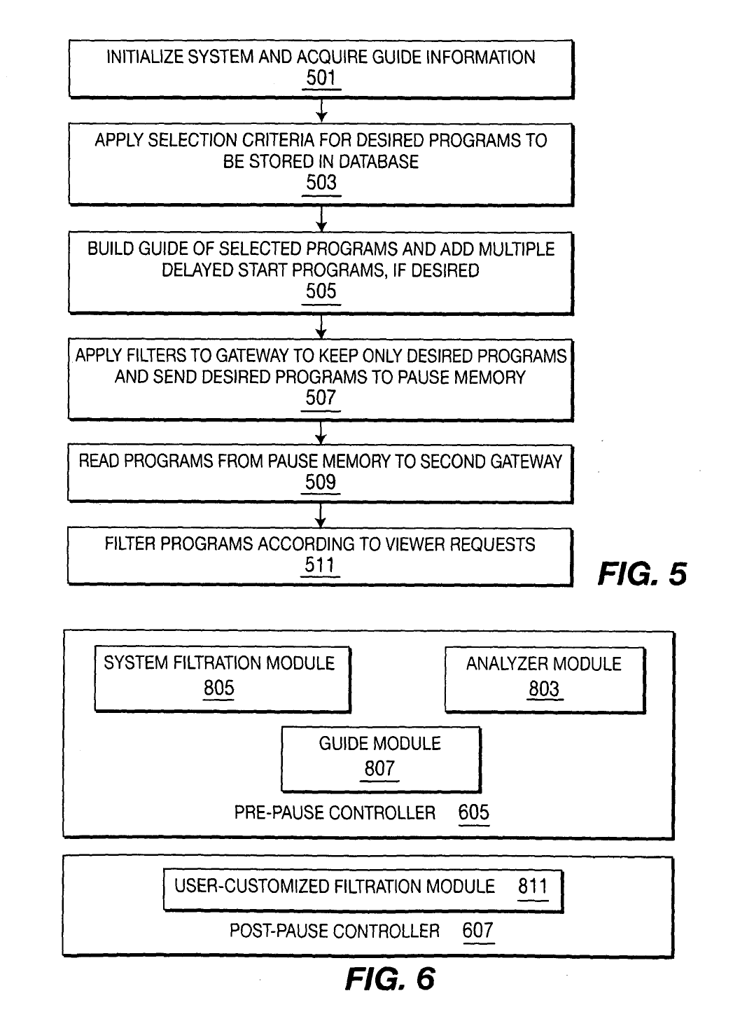

FIG. 5 is an exemplary method flow for providing database filtering in a broadcast multimedia system having a global pause function according to an aspect of the present principles. In step 501, the system is turned on and initialized, e.g., preferably before the flight begins, to acquire guide data assuming all tuners are active. For example, if the pause buffer is 30 minutes, start 30 minutes early to optimize the system memory and the offering to the passengers/viewers.

In step 503 the program guide data is analyzed and applied. For example, the following information can be determined from the guide:

a. Length of program
b. Stream IDs
c. Percent of program in progress
d. Status of program from Pay-Per-View, Local Channel, . . .
e. Title of program
f. Rating of program
g. Start time
h. Type of program (live news, sports, etc.)

Any selection criteria can be applied to determine which data streams should be filtered. For example, the types of programs that would typically be filtered on a flight would be pay-per-view streams, long movies (2+ hours) that occur on a short flights (50 minutes), programs that are already, e.g., half over, the programs that have ratings that are more restrictive than the plane's requirements (such as ‘R’ rated content can not be allowed on the plane), certain advertising channels, gaming programs, and some satellite system support packets, etc. Programs that might be desired are G or PG rated programs that fit within the flight time, news programs, nature programs, and free live sports events.

In step 505, a guide of the desired programs is created. That is, a program guide is created from which the viewer can select only non-filtered out programs (at any desired start time which is offered). Optionally, the guide can include multiple delayed-start times for certain programs.

In step 507, the programs are filtered to save only the desired data streams as per the selection criteria up to the limit of the system bandwidth for reading the streams. Preferably, only the programs that are suitable or desirable for viewing are saved in a pause memory.

In step 509 the saved programs are read from the pause memory to the post-pause controller 607. In step 511, the saved programs are filtered in accordance with viewers' requests to provide user-specified programs to individual viewers.

In situations where a separate popular stream packet processor is being employed, the most popular programs are saved in the memory of the popular stream processor to allow enough bandwidth for, e.g., multiple reads and one write. Multiple time-delayed start times can be created for popular programs, and/or multiple listings showing real-time vs. delayed time for each program. Ultimately, all content from a pause packet processor or a popular stream packet processor is filtered by a post-pause controller 607 in accordance with user-specified requirements.

FIG. 6 is an exemplary schematic illustration of a pre-pause controller and a post-pause controller according to an aspect of the present principles. The pre-pause controller 605 includes an analyzer module 102 configured to perform at least the steps 501 and 503 of FIG. 5, that is, to acquire and analyze program guide data, assess the size of pause buffers, apply selection criteria for desired programs to be stored in a pause database, review the program guide to determine multiple time-delayed start content and re-run the guide to accommodate the pause.

A system filtration module 805 is provided for performing, e.g., at least step 507, namely filtering out undesired program data streams from being saved in a pause packet processor. The filtration module 805 is provided to screen the packets in real time to determine if they are to be saved in memory 211. The desired data streams are saved, preferably up to the limit of the system bandwidth for reading the streams.

Advantageously, this pre-selection of programs to be saved results in an overall reduction of data and helps reduce the bandwidth needed. Memory 211 thus saves only the non-filtered out packets. Data streams to be saved can comprise programs which are popular, or which are otherwise suitable for or likely to be viewed by passengers.

A guide module 807 is provided for performing at least step 505, that is creating a program guide which enables a viewer to select only the non-filtered out programs. The guide module 807 can create a guide having multiple start times for popular programs, as well as multiple listings for each program that show both the real time versus the delayed starts for each program.

The post pause controller 607 can include a user-customized filtration module 811 for receiving and assessing viewer program requests, and filtering the programs to deliver only the requested program to the viewer who requested it.

Although the embodiment which incorporates the teachings of the present principles has been shown and described in detail herein, those skilled in the art can readily devise many other varied embodiments that still incorporate these teachings. Having described preferred embodiments for a system and method for providing database filtering in a global system pause function for broadcast multimedia programming (which are intended to be illustrative and not limiting), it is noted that modifications and variations can be made by persons skilled in the art in light of the above teachings. It is therefore to be understood that changes can be made in the particular embodiments of the principles disclosed which are within the scope and spirit of the inventive principles as outlined by the appended claims.

Having thus described the invention with the details and particularity required by the patent laws, what is claimed and desired protected by Letters Patent is set forth in the appended claims:

1. A system, comprising:
a pre-pause controller configured for processing audio and video data content received from a packet processor, the pre-pause controller comprising:
an analyzer for analyzing program guide data to determine desired content to be stored in a memory;
a filter for filtering desired data content to yield primary filtered content to be saved in the memory; and
a guide for creating a program guide from the primary filtered content to be offered to viewers.

2. The system of claim 1, wherein the memory is provided in a pause packet processor configured for storing paused data content.

3. The system of claim 2, further comprising a post-pause controller functionally connected to the pause packet processor, the post-pause controller including a user-customized filter for filtering the primary filtered content in accordance with viewer requests.

4. The system of claim 3, wherein the post-pause controller provides secondary filtered content to the viewers.

5. The system of claim 1, wherein the audio and video data content received from the packet processor comprises data packets received from at least one tuner.

6. The system of claim 1, wherein the analyzing criteria is applied to exclude content deemed unsuitable for the viewers.

7. The system of claim 1, wherein the analyzer module is further configured to use analyzing criteria to filter out the undesired content.

8. A system, comprising:
a pre-pause controller configured for processing audio and video data content prior to the global pause function, said data content being received from a packet processor (102), the pre-pause controller comprising:
an analyzer for acquiring and analyzing program guide data to apply selection criteria to determine desired content to be stored in a pause function memory device;
a filter for filtering undesired content and enabling desired data content comprising primary filtered content to be saved in at least one pause function memory device;
a guide for creating a program guide comprising only primary filtered content to be offered to viewers; and
a post-pause controller for processing content subsequent to the global pause function, the post-pause controller including a user-customized filter for filtering the primary filtered content in accordance with viewer requests.

9. The system of claim 8, wherein the pause function memory device is provided in a pause packet processor configured for storing paused data content.

10. The system of claim 9, wherein the post-pause controller is functionally connected to the pause packet processor.

11. The system of claim 8, wherein the audio and video data content comprises data packets received from at least one tuner.

12. The system of claim 8, wherein the selection criteria is applied to exclude data content deemed unsuitable for the viewers.

13. The system of claim 8, wherein the post-pause controller provides secondary filtered content to the viewers.

14. The system of claim 8, wherein the program guide data comprises at least one of program lengths, program titles, program ratings, program start times, percent of program in progress, and program types.

15. A method, comprising:
analyzing program guide data for determining desired data content to be stored in a pause function memory; and
filtering the desired data content to yield primary filtered content saved in the pause function memory

16. The method of claim 15, further comprising the step of creating a program guide comprising only primary filtered content to be offered to viewers.

17. The method of claim 15, further comprising the step of processing the primary filtered content subsequent to the global pause function for filtering the primary filtered content in accordance with viewer requests to provide secondary filtered content to the viewers.

18. The method of claim 15, wherein analyzing criteria is applied to exclude data content deemed unsuitable for the viewers.

19. The method of claim 15, wherein the program guide data comprises at least one of program lengths, program titles, program ratings, program start times, percent of program in progress, and program types.

20. The method of claim 15, further comprising the step of using analyzing criteria to filter the undesired content in real-time.
